(19) United States
(12) Patent Application Publication
(10) Pub. No.: US 2026/0263949 A1
(43) Pub. Date: Sep. 10, 2026

(54) ONE OR MORE NON-TRANSITORY COMPUTER-READABLE MEDIA, GAME SYSTEM, INFORMATION PROCESSING METHOD, AND INFORMATION PROCESSING APPARATUS

(71) Applicant: NINTENDO CO., LTD., Kyoto (JP)

(72) Inventors: Koichi KAWAMOTO, Kyoto (JP); Toyokazu NONAKA, Kyoto (JP); Shinya SAITO, Kyoto (JP); Nobuo MATSUMIYA, Kyoto (JP); Kodai MATSUMOTO, Kyoto (JP); Tomohiro YAMAMURA, Kyoto (JP)

(21) Appl. No.: 19/184,813

(22) Filed: Apr. 21, 2025

(30) Foreign Application Priority Data
Mar. 6, 2025 (JP) 2025-035772

(51) Int. Cl. A63F 13/812; A63F 13/335; A63F 13/5252; A63F 13/57

(52) U.S. Cl. CPC A63F 13/812; A63F 13/335; A63F 13/5252; A63F 13/57

(57) ABSTRACT

An information processing system includes a parent apparatus and a child apparatus. To the parent apparatus, first and second operation devices are connected. The parent apparatus acquires first operation data and second operation data based on inputs to the first and second operation devices. To the child apparatus, third and fourth operation devices are connected. The parent apparatus acquires third operation data and fourth operation data based on inputs to the third and fourth operation devices from the child apparatus. The parent apparatus performs game processing including controlling first to fourth player characters based on the first to fourth operation data, generates a first image, displays the first image on a display device of the parent apparatus, generates a second image, and transmits the second image to the child apparatus. The child apparatus displays the second image received from the parent apparatus on a display device of the child apparatus.

### CROSS REFERENCE TO RELATED APPLICATION

This application claims priority to Japanese Patent Application No. 2025-035772 filed on Mar. 6, 2025, the entire contents of which are incorporated herein by reference.

### FIELD

An exemplary embodiment relates to one or more non-transitory computer-readable media, a game system, an information processing method, and an information processing apparatus.

### BACKGROUND AND SUMMARY

Conventionally, there is a technique in which one of a plurality of information processing apparatuses is set as a parent apparatus, the other apparatuses are set as child apparatuses, and the parent apparatus distributes images to the child apparatuses, whereby a game is performed between the plurality of information processing apparatuses.

However, there is room for performing a multiplay game by a greater variety of methods using an information processing system having the function of distributing images from a parent apparatus to child apparatuses.

An exemplary embodiment discloses an information processing system having the function of distributing images from a parent apparatus to child apparatuses and capable of performing a multiplay game by a variety of new methods.

The exemplary embodiment employs the following configurations.

### First Configuration

A first configuration is one or more non-transitory computer-readable media having stored therein instructions that, when executed, cause one or more processors of a first information processing apparatus to execute information processing. The game processing includes: communicating with a second information processing apparatus; acquiring first operation data and second operation data based on inputs to a first operation device and a second operation device connected to the first information processing apparatus; acquiring third operation data and fourth operation data based on inputs to a third operation device and a fourth operation device connected to the second information processing apparatus, the third operation data and fourth operation data received from the second information processing apparatus; in a virtual space, performing game processing including controlling a first player character based on the first operation data, controlling a second player character based on the second operation data, controlling a third player character based on the third operation data, and controlling a fourth player character based on the fourth operation data; generating a first image based on a first virtual camera in the virtual space; generating a second image based on a second virtual camera in the virtual space; outputting the first image to a display device included in or connected to the first information processing apparatus; and transmitting the second image to the second information processing apparatus.

Based on the above, it is possible to achieve a multiplay game that uses two information processing apparatuses by game processing on a first information processing apparatus. A plurality of operation devices are connected to each of the information processing apparatuses, whereby more people than the number of information processing apparatuses can perform a multiplay game.

### Second Configuration

According to a second configuration, in the first configuration, the game processing may further include: controlling the first and second player characters in a first range in the virtual space; and controlling the third and fourth player characters in a second range in the virtual space.

Based on the above, it is possible to perform a game where player characters are placed in a divided manner in two areas.

### Third Configuration

According to a third configuration, in the second configuration, the first virtual camera may be placed to be directed from the first range side to the second range side, and the second virtual camera may be placed to be directed from the second range side to the first range side.

Based on the above, it is possible to display images different in viewpoint on display devices of the information processing apparatuses.

### Fourth Configuration

According to the fourth configuration, in the second configuration, the first and second player characters may be placed to face the third and fourth player characters, the first virtual camera may be placed to be directed from a back side of the first and second player characters to the third and fourth player characters, and the second virtual camera may be placed to be directed from a back side of the third and fourth player characters to the first and second player characters.

Based on the above, it is possible to perform a game where first and second player characters and third and fourth player characters face each other.

### Fifth Configuration

According to the fifth configuration, in the third or fourth configuration, the game processing may further include causing a first team including the first and second player characters and a second team including the third and fourth player characters to compete against each other.

Based on the above, the information processing apparatuses can assemble teams, and the teams can compete against each other.

### Sixth Configuration

According to the sixth configuration, in the fifth configuration, the game processing may further include moving a moving object in the virtual space by actions of the first to fourth player characters based on the first to fourth operation data.

Based on the above, it is possible to perform a game that uses a moving object.

### Seventh Configuration

According to a seventh configuration, in the sixth configuration, the game processing may be game processing regarding a sport game where the game progresses based on a determination that is success according to the movement of the moving object.

Based on the above, it is possible to perform a sport game that uses a moving object.

Another configuration may be the first information processing apparatus, or may be an information processing system including the first information processing apparatus and the second information processing apparatus, or may be an information processing method performed in an information processing system.

According to the exemplary embodiment, more people than the number of information processing apparatuses can perform a multiplay game.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of an information processing apparatus 1 in the state where a left controller 3 and a right controller 4 are attached to a main body apparatus 2;

FIG. 2 is an example non-limiting diagram showing an example of the information processing apparatus 1 in the state where the left controller 3 and the right controller 4 are detached from the main body apparatus 2;

FIG. 3 is an example non-limiting block diagram showing an example of the internal configuration of the information processing apparatus 1;

FIG. 4 is an example non-limiting diagram showing an example of a game system 10 and is an example non-limiting diagram showing an overview of the game system 10 configured by a plurality of information processing apparatuses 1 performing local communication with each other;

FIG. 5 is an example non-limiting diagram showing an example of the game system 10 and is an example non-limiting diagram showing an overview of the game system 10 configured by the plurality of information processing apparatuses 1 performing Internet communication with each other;

FIG. 6 is an example non-limiting diagram showing an example of the configuration of the game system 10 where a game according to an exemplary embodiment is performed;

FIG. 7A is an example non-limiting diagram showing an example of a first image displayed on a display 12a of a parent apparatus in a case where a competition game according to the exemplary embodiment is performed;

FIG. 7B is an example non-limiting diagram showing an example of a second image displayed on a display 12b of a child apparatus in a case where the competition game according to the exemplary embodiment is performed;

FIG. 8 is an example non-limiting diagram showing an example of data stored in a parent apparatus;

FIG. 9 is an example non-limiting diagram showing an example of data stored in a child apparatus;

FIG. 10 is an example non-limiting flow chart showing an example of a parent apparatus process performed by the parent apparatus when a predetermined game is performed in the game system 10; and

FIG. 11 is an example non-limiting flow chart showing an example of a child apparatus process performed by the child apparatus.

### DETAILED DESCRIPTION OF NON-LIMITING EXAMPLE EMBODIMENTS

### Description of Information Processing Apparatus

An information processing apparatus used in an example of an exemplary embodiment is described below. An example of an information processing apparatus 1 includes a main body apparatus 2, a left controller 3, and a right controller 4. Each of the left controller 3 and the right controller 4 is configured to be attachable to and detachable from the main body apparatus 2. That is, the information processing apparatus 1 can be used as a unified apparatus obtained by attaching the left controller 3 and the right controller 4 to the main body apparatus 2. Further, the information processing apparatus 1 can also be used by detaching the left controller 3 and the right controller 4 from the main body apparatus 2. Hereinafter, the configuration of the information processing apparatus 1 according to the exemplary embodiment is described, and then, a game system including a plurality of information processing apparatuses 1 is described.

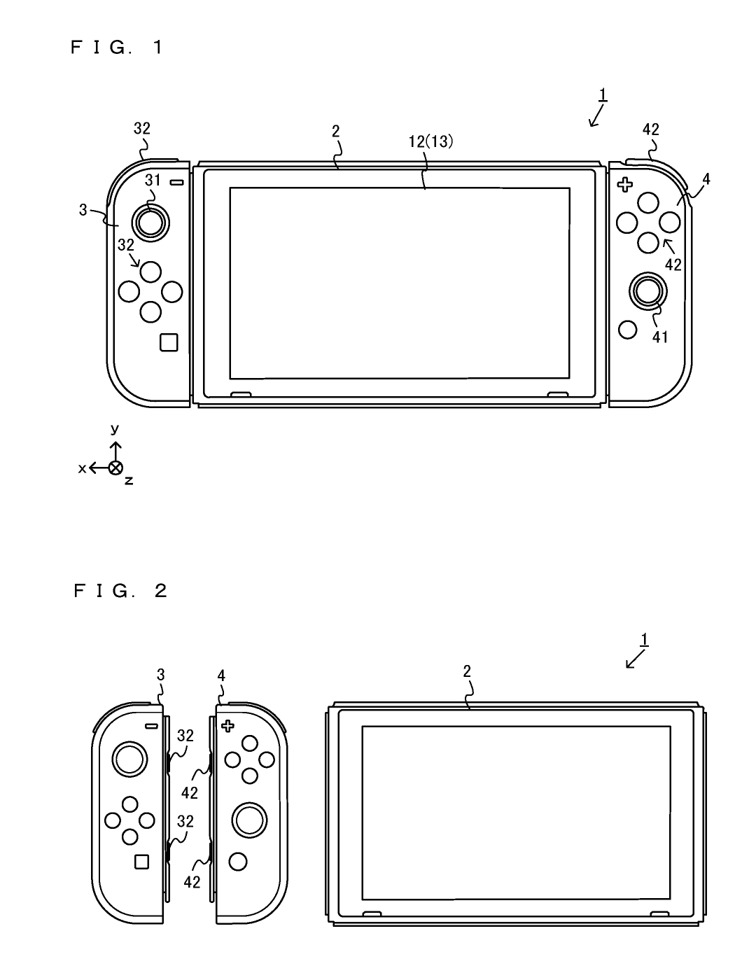

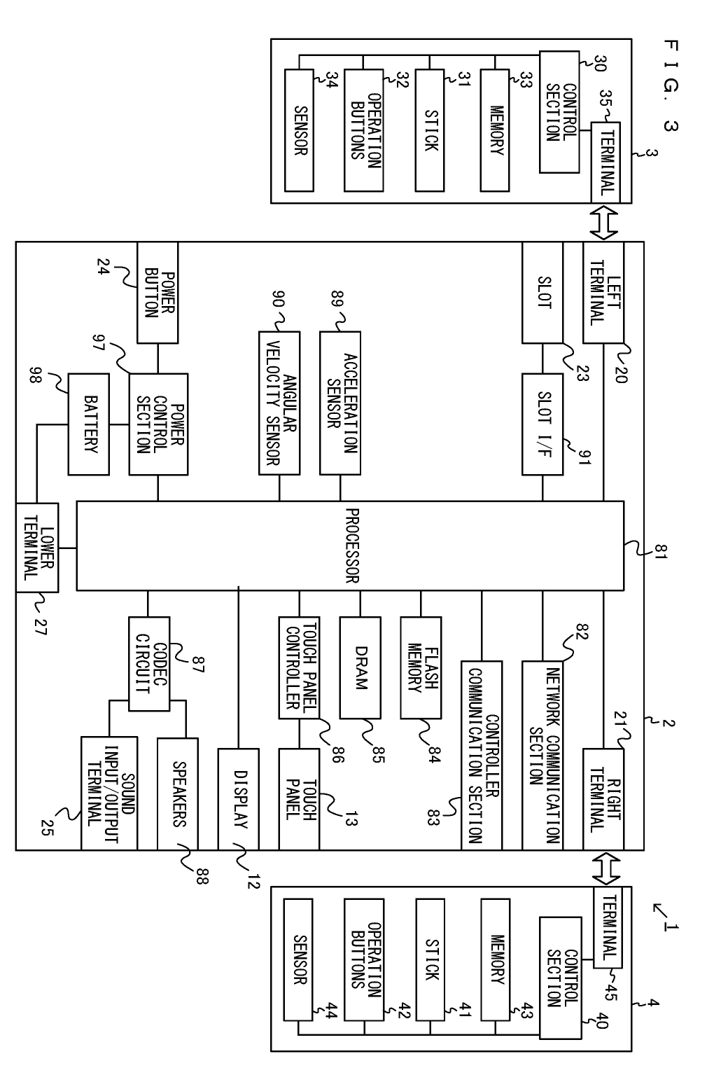

FIG. 1 is a diagram showing an example of the information processing apparatus 1 in the state where the left controller 3 and the right controller 4 are attached to the main body apparatus 2. FIG. 2 is a diagram showing an example of the information processing apparatus 1 in the state where the left controller 3 and the right controller 4 are detached from the main body apparatus 2. As shown in FIG. 1, each of the left controller 3 and the right controller 4 is attached to and unified with the main body apparatus 2. The main body apparatus 2 is an apparatus for performing various processes (e.g., game processing) in the information processing apparatus 1.

The main body apparatus 2 includes a display 12. The display 12 displays an image generated by the main body apparatus 2. The display 12 may be a display device of any type. For example, the display 12 may be a liquid crystal display device (LCD), or may be an organic EL display device.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

Each of the left controller 3 and the right controller 4 has a vertically long shape (i.e., a long shape in a y-axis direction shown in FIG. 1). In the state where each of the left controller 3 and the right controller 4 is detached from the main body apparatus 2, the controller can be held in the orientation in which the controller is vertically long, and can also be held in the orientation in which the controller is horizontally long.

The left controller 3 includes an analog stick 31 for a user to provide a direction input, and a plurality of operation buttons 32 for the user to perform a pressing operation. The right controller 4 includes an analog stick 41 for the user to provide a direction input, and a plurality of operation buttons 42 for the user to perform a pressing operation. Each of the left controller 3 and the right controller 4 may include an acceleration sensor and an angular velocity sensor within and be able to detect the motion and the orientation of the controller. Hereinafter, the left controller 3 and the right controller 4 are occasionally collectively referred to as a "first controller".

The main body apparatus 2 to which the left controller 3 and the right controller 4 are attached (the information processing apparatus 1) is of a size that can be carried by the user. For example, the user performs a game operation using the left controller 3 and the right controller 4 by holding the left controller 3 unified with the main body apparatus 2 with their left hand and holding the right controller 4 unified with the main body apparatus 2 with their right hand and plays a game while viewing a game image displayed on the display 12 in front of the user. Hereinafter, a play form in which as described above, in the state where the left controller 3 and the right controller 4 are attached to the main body apparatus 2, the user performs a game operation using the left controller 3 and the right controller 4 and plays a game while viewing a game image displayed on the display 12 is occasionally referred to as a "mobile mode".

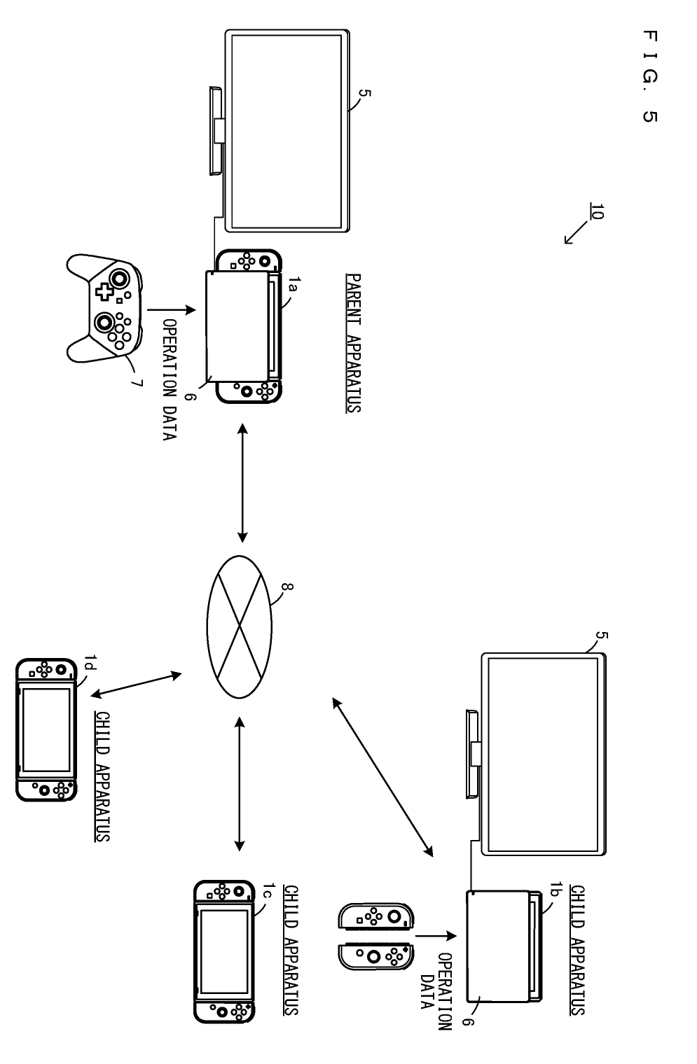

As shown in FIG. 2, the left controller 3 and the right controller 4 can be detached from the main body apparatus 2. In the state where the left controller 3 and the right controller 4 are detached from the main body apparatus 2, the left controller 3 and the right controller 4 are wirelessly connected to the main body apparatus 2. For example, a stand for standing the main body apparatus 2 is provided on a back surface of the main body apparatus 2. Using the stand, the user can place the main body apparatus 2 in the state where the main body apparatus 2 stands on a table so that the screen of the display 12 is almost perpendicular to the table. Alternatively, the user may place the main body apparatus 2 on the table so that the screen of the display 12 of the main body apparatus 2 faces up. The user can detach the left controller 3 and the right controller 4 from the main body apparatus 2, perform a game operation using the left controller 3 and/or the right controller 4, and play a game while viewing a game image displayed on the display 12 of the main body apparatus 2 placed on the table. Hereinafter, a play form in which as described above, the left controller 3 and the right controller 4 are wirelessly connected to the main body apparatus 2, and the user performs a game operation using the left controller 3 and/or the right controller 4 and plays a game while viewing a game image displayed on the display 12 is occasionally referred to as a "table mode". To the main body apparatus 2, a second controller 7 (see FIG. 5) different from the left controller 3 and the right controller 4 may be able to be wirelessly connected. The second controller may be a controller that can be operated by the user by holding the controller with both hands. A play form in which as described above, the second controller is wirelessly connected to the main body apparatus 2, and the user performs a game operation using the second controller and plays a game while viewing a game image displayed on the display 12 is also referred to as a "table mode". Hereinafter, the first controller and the second controller are occasionally collectively referred to as a "controller".

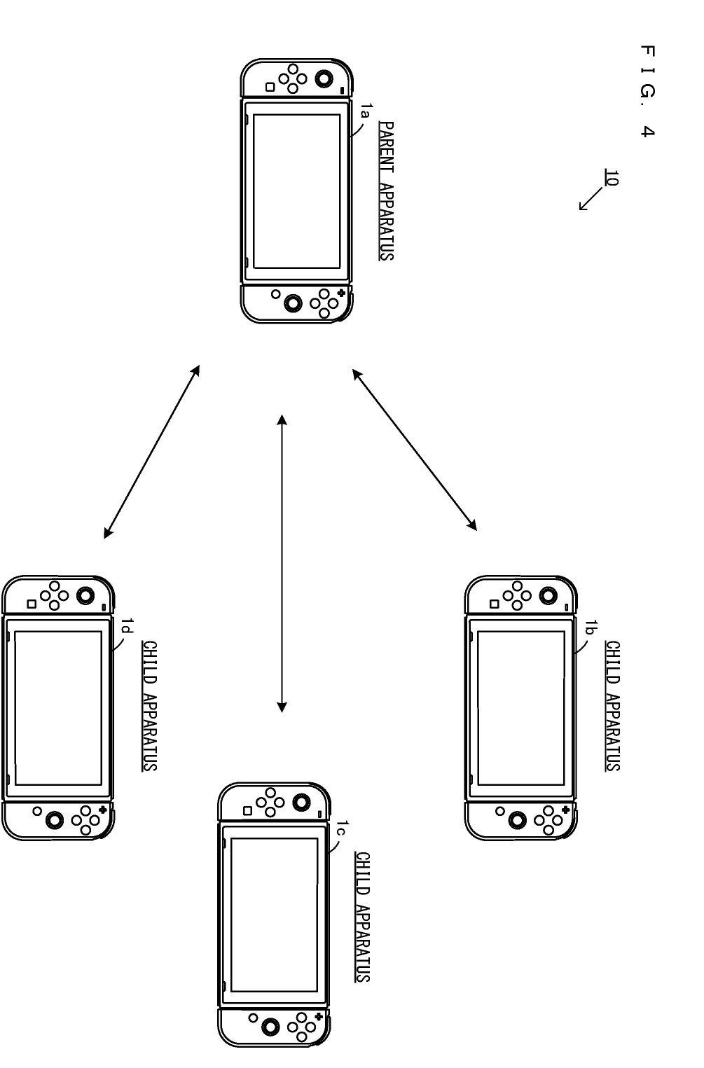

The user can also connect the main body apparatus 2 to a stationary monitor (e.g., television) 5 via a cradle 6 and play a game while viewing a game image displayed on the stationary monitor 5 (see FIG. 5). In the main body apparatus 2, a lower terminal 27 (see FIG. 3) for connecting to the cradle 6 is provided. The main body apparatus 2 is connected to the stationary monitor 5 in a wired manner via the cradle 6. A play form in which as described above, the user plays a game while viewing an image displayed on the external stationary monitor 5 different from the display 12 is occasionally referred to as a "stationary mode". In a case where the information processing apparatus 1 operates in the stationary mode, the first controller (the left controller 3 and the right controller 4) may be detached from the main body apparatus 2 and wirelessly connected to the main body apparatus 2, and the user may perform a game operation using the first controller. Alternatively, in a case where the information processing apparatus 1 operates in the stationary mode, in the state where the left controller 3 and the right controller 4 are attached to the main body apparatus 2, another first controller or the second controller may be wirelessly connected to the main body apparatus 2, and the user may perform a game operation using the first controller or the second controller.

Next, the internal configuration of the information processing apparatus 1 is described. FIG. 3 is a block diagram showing an example of the internal configuration of the information processing apparatus 1.

As shown in FIG. 3, the main body apparatus 2 includes a processor 81. The processor 81 is an information processing section for executing various types of information processing to be executed by the main body apparatus 2. For example, the processor 81 may be composed of one or more CPUs (Central Processing Units), or may be composed of a SoC (System-on-a-chip) including one or more CPUs and one or more GPUs (Graphics Processing Units). The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as "I/F") 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, the network communication section 82 can directly wirelessly communicate with another main body apparatus 2 present in the communication range of this main body apparatus 2 using a predetermined communication method (e.g., a communication method based on a unique protocol or a method compliant with the Wi-Fi standard). Via a wireless LAN access point present in the communication range of this main body apparatus 2, the network communication section 82 may also be able to communicate with another main body apparatus 2 connected to a local area network including the access point using a method compliant with the Wi-Fi standard. Here, such direct communication with another main body apparatus 2 and such communication in a local area network via a wireless LAN access point are referred to as "local communication". The network communication section 82 can connect to the Internet by connecting to a wireless LAN using a method compliant with the Wi-Fi standard, and can communicate with another apparatus connected to the Internet. The main body apparatus 2 may be able to connect to a wired LAN, and may be able to connect to the Internet via the wired LAN. For example, the main body apparatus 2 may be able to connect to the wired LAN via the cradle 6. Here, such communication with another apparatus via the Internet is referred to as "Internet communication".

The main body apparatus 2 includes a controller communication section 83. The controller communication section 83 is connected to the processor 81. The controller communication section 83 wirelessly communicates with the left controller 3 and/or the right controller 4. The controller communication section 83 can also wirelessly communicate with the second controller. The communication method between the main body apparatus 2 and the left controller 3 and the right controller 4 (or the second controller) is optional. In the exemplary embodiment, the controller communication section 83 performs communication compliant with the Bluetooth (registered trademark) standard with the left controller 3 and with the right controller 4.

The processor 81 is connected to a left terminal 20, a right terminal 21, and a lower terminal 27. When performing wired communication with the left controller 3, the processor 81 transmits data to the left controller 3 via the left terminal 20 and also receives operation data from the left controller 3 via the left terminal 20. Further, when performing wired communication with the right controller 4, the processor 81 transmits data to the right controller 4 via the right terminal 21 and also receives operation data from the right controller 4 via the right terminal 21. Further, when communicating with the cradle 6, the processor 81 transmits data to the cradle 6 via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle 6, the main body apparatus 2 can output data (e.g., image data or sound data) to the stationary monitor 5 or the like via the cradle 6.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. Based on a signal from the touch panel 13, the touch panel controller 86 generates, for example, data indicating the position where a touch input is provided. Then, the touch panel controller 86 outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

Further, the main body apparatus 2 includes an acceleration sensor 89. In the exemplary embodiment, the acceleration sensor 89 detects the magnitudes of accelerations along predetermined three axial (e.g., xyz axes shown in FIG. 1) directions. It should be noted that the acceleration sensor 89 may detect an acceleration along one axial direction or accelerations along two axial directions.

Further, the main body apparatus 2 includes an angular velocity sensor 90. In the exemplary embodiment, the angular velocity sensor 90 detects angular velocities about predetermined three axes (e.g., the xyz axes shown in FIG. 1). It should be noted that the angular velocity sensor 90 may detect an angular velocity about one axis or angular velocities about two axes.

The acceleration sensor 89 and the angular velocity sensor 90 are connected to the processor 81, and the detection results of the acceleration sensor 89 and the angular velocity sensor 90 are output to the processor 81. Based on the detection results of the acceleration sensor 89 and the angular velocity sensor 90, the processor 81 can calculate information regarding the motion and/or the orientation of the main body apparatus 2.

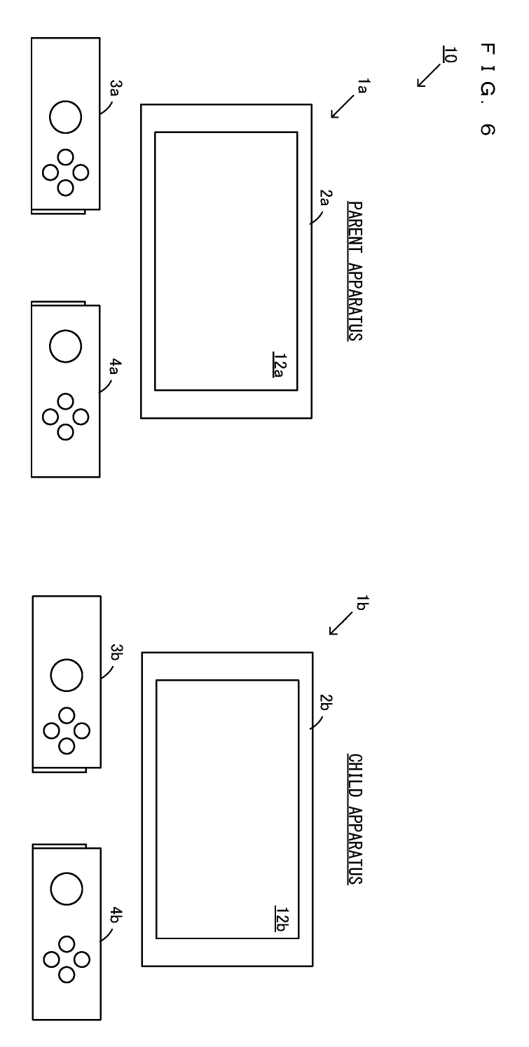

The main body apparatus 2 includes a power button 24, a power control section 97, and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 20, and the right terminal 21). Based on a command from the processor 81, the power control section 97 controls the supply of power from the battery 98 to the above components.

Further, the battery 98 is connected to the lower terminal 27. When an external charging device (e.g., the cradle 6) is connected to the lower terminal 27, and power is supplied to the main body apparatus 2 via the lower terminal 27, the battery 98 is charged with the supplied power.

The left controller 3 includes a terminal 35 that is connected to the left terminal 20 of the main body apparatus 2. The left controller 3 also includes a control section 30. The control section 30 is connected to components including the terminal 35. The control section 30 controls the method for communication performed by the left controller 3 with the main body apparatus 2. In the exemplary embodiment, the control section 30 can communicate with the main body apparatus 2 through both wired communication via the terminal 35 and wireless communication via an antenna (not shown). That is, when the left controller 3 is attached to the main body apparatus 2, the control section 30 communicates with the main body apparatus 2 via the terminal 35. Further, when the left controller 3 is detached from the main body apparatus 2, the control section 30 wirelessly communicates with the main body apparatus 2 (specifically, the controller communication section 83). The wireless communication between the controller communication section 83 and the control section 30 is performed in accordance with the Bluetooth (registered trademark) standard, for example.

Further, the left controller 3 includes a memory 33 such as a flash memory. The control section 30 includes, for example, a microcomputer (or a microprocessor) and executes firmware stored in the memory 33, thereby performing various processes.

The left controller 3 includes the analog stick ("stick" in FIG. 3) 31 and the plurality of operation buttons 32. Information regarding an operation performed on each of the analog stick 31 and the plurality of operation buttons 32 is output to the control section 30 repeatedly at appropriate timing.

Further, the left controller 3 includes a sensor 34. The sensor 34 includes an acceleration sensor and an angular velocity sensor. The acceleration sensor detects the magnitudes of accelerations along the xyz axis directions shown in FIG. 1, and the angular velocity sensor detects angular velocities about the xyz axes. The detection results of the acceleration sensor and the angular velocity sensor are output to the control section 30 repeatedly at appropriate timing.

The control section 30 acquires information regarding an input (specifically, information regarding an operation on each of the analog stick 31 and the operation buttons 32 or the detection result of the sensor 34) from each of the operation buttons 32, the analog stick 31, and the sensor 34. The control section 30 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can determine operations on the analog stick 31 and the operation buttons 32 based on the operation data. Further, based on the detection result of the sensor 34, the main body apparatus 2 can acquire information regarding the motion and/or the orientation of the left controller 3.

Although not shown in the figures, the left controller 3 includes a battery that supplies power to the above components. The left controller 3 may also include a vibrator.

As shown in FIG. 3, the right controller 4 includes a terminal 45 that is connected to the right terminal 21 of the main body apparatus 2, a control section 40, a memory 43, a stick 41, a plurality of operation buttons 42, and a sensor 44. These components have functions similar to those of the above components of the left controller 3, and therefore are not described.

### Description of Game System Including Plurality of Information Processing Apparatuses

A description is given below of an example of a game system 10 for performing a game according to the exemplary embodiment described below. The game system 10 is a system configured by a plurality of information processing apparatuses 1 communicating with each other. FIG. 4 is a diagram showing an example of the game system 10 and is a diagram showing an overview of the game system 10 configured by the plurality of information processing apparatuses 1 performing the local communication with each other. FIG. 5 is a diagram showing an example of the game system 10 and is a diagram showing an overview of the game system 10 configured by the plurality of information processing apparatuses 1 performing the Internet communication with each other.

As shown in FIGS. 4 and 5, the game system 10 includes a plurality of information processing apparatuses 1. For example, the game system 10 includes an information processing apparatus 1a, an information processing apparatus 1b, an information processing apparatus 1c, and an information processing apparatus 1d.

Although FIGS. 4 and 5 exemplify cases where the game system 10 includes four information processing apparatuses 1, the number of information processing apparatuses 1 included in the game system 10 may be optional. In both the communication forms shown in FIGS. 4 and 5, the plurality of information processing apparatuses 1 included in the game system 10 may operate in the mobile mode, or may operate in the stationary mode, or may operate in the table mode, or these modes may coexist. For example, in the communication form shown in FIG. 4, all the information processing apparatuses 1a to 1d may operate in the mobile mode, or may operate in the stationary mode, or may operate in the table mode, or the mobile mode, the stationary mode, and the table mode may coexist. Although in the game system 10 shown in FIG. 5, information processing apparatuses in the stationary mode (1a and 1b) and information processing apparatuses in the mobile mode (1c and 1d) coexist, an information processing apparatus in the table mode may be included, or all the information processing apparatuses 1a to 1d may operate in the mobile mode, or may operate in the stationary mode, or may operate in the table mode.

In FIGS. 4 and 5, the information processing apparatus 1a functions as a parent apparatus. The information processing apparatus 1a as the parent apparatus executes a game program. The processor 81 of the information processing apparatus 1a executes the game program, thereby executing game processing regarding a predetermined game. For example, an external storage medium that stores the game program can be attached to the slot 23 of the information processing apparatus 1a, and the processor 81 of the information processing apparatus 1a can read the game program stored in the external storage medium into the DRAM 85 and execute the game program. The game program may be stored in the flash memory 84 of the information processing apparatus 1a, or may be stored in another storage device that can be read by the information processing apparatus 1a. The predetermined game may be any game such as a racing game, a card game, a table game, a sport game, a fighting game, a shooting game, a role-playing game, a music game, or the like.

On the other hand, in FIGS. 4 and 5, the information processing apparatuses 1b to 1d function as child apparatuses. Each of the information processing apparatuses 1b to 1d as the child apparatuses may not store the game program for executing the predetermined game and not be able to execute the game program. That is, an external storage medium that stores the game program is not attached to the slot 23 of the child apparatus, and the game program is not stored in the flash memory 84 of the child apparatus, either.

Each child apparatus may also store the game program, but any one of the plurality of information processing apparatuses 1 may function as a parent apparatus, the remaining information processing apparatuses 1 may function as child apparatuses, and only the parent apparatus may execute game processing.

A plurality of child apparatuses may include an apparatus that only functions as a child apparatus.

A parent apparatus and child apparatuses may be information processing apparatuses of same type (e.g., game apparatuses of the same type). A parent apparatus and child apparatuses may be information processing apparatuses of different types. A plurality of child apparatuses may include an information processing apparatus of the same type as a parent apparatus and an information processing apparatus of a different type from the parent apparatus.

As shown in FIG. 4, a parent apparatus and child apparatuses may directly communicate with each other through local communication (e.g., a communication method based on a unique protocol or a method compliant with the Wi-Fi standard). As shown in FIG. 5, a parent apparatus and child apparatuses may communicate with each other via the Internet 8. In the exemplary embodiment, a predetermined game is executed using a parent apparatus and child apparatuses. The parent apparatus and the child apparatuses establish connections with each other before the predetermined game starts.

Specifically, a parent apparatus acquires operation data relating to an operation on the controller (the first controller or the second controller) of the parent apparatus. Here, the operation data relating to an operation on the controller of the parent apparatus is referred to as "parent apparatus operation data". A child apparatus transmits operation data relating to an operation on the controller (the first controller or the second controller) of the child apparatus to the parent apparatus. Here, the operation data transmitted from the child apparatus to the parent apparatus is referred to as "child apparatus operation data".

The parent apparatus performs game processing based on the parent apparatus operation data. The parent apparatus also receives the child apparatus operation data transmitted from the child apparatus and performs game processing based on the child apparatus operation data. The content of the game processing differs depending on the type of the game.

Next, the parent apparatus generates image data based on the result of the game processing. Specifically, the parent apparatus generates parent apparatus image data and child apparatus image data.

The parent apparatus outputs the generated parent apparatus image data to the display 12 or the stationary monitor 5. Consequently, a parent apparatus game image is displayed on the display 12 or the stationary monitor 5 of the parent apparatus. The parent apparatus also transmits the generated child apparatus image data to the child apparatus. The child apparatus receives the child apparatus image data transmitted from the parent apparatus and outputs the child apparatus image data to the display 12 or the stationary monitor 5. Consequently, a child apparatus game image is displayed on the display 12 or the stationary monitor 5 of the child apparatus. The parent apparatus may generate parent apparatus sound data and output a sound based on the sound data. The parent apparatus may also generate child apparatus sound data and transmit the child apparatus sound data to the child apparatus, and the child apparatus may output a sound based on the child apparatus sound data.

As described above, the game system 10 for performing the game according to the exemplary embodiment includes a plurality of information processing apparatuses 1, any one of the plurality of information processing apparatuses 1 functions as a parent apparatus, and the other information processing apparatuses 1 function as child apparatuses. Game processing is performed based on parent apparatus operation data relating to an operation performed on the parent apparatus. Child apparatus operation data relating to an operation performed on each child apparatus is transmitted from the child apparatus to the parent apparatus, and game processing based on the child apparatus operation data is performed by the parent apparatus. The parent apparatus generates a game image relating to the result of the game processing and displays the game image on the display 12 or the stationary monitor 5 of the parent apparatus. The parent apparatus also transmits a game image relating to the result of the game processing to the child apparatus, and the game image is displayed by the child apparatus. Consequently, a game is performed in the game system 10 including the parent apparatus and the child apparatuses.

Next, a description is given of the game according to the exemplary embodiment performed using the game system 10 as described above.

### Exemplification of Game Performed in Game System

An example of a game according to the exemplary embodiment is a multiplay game performed by four users in a game system including two information processing apparatuses 1. For example, the game according to the exemplary embodiment is performed through the above local communication. The game according to the exemplary embodiment may also be performed through the Internet communication. The game according to the exemplary embodiment is described below.

FIG. 6 is a diagram showing an example of the configuration of the game system 10 where the game according to the exemplary embodiment is performed.

As shown in FIG. 6, the game system 10 where the game according to the exemplary embodiment is performed includes a first information processing apparatus 1a and a second information processing apparatus 1b. For example, the first information processing apparatus 1a and the second information processing apparatus 1b operate in the above table mode.

To the main body apparatus 2a, a left controller 3a and a right controller 4a are wirelessly connected. To the main body apparatus 2b, a left controller 3b and a right controller 4b are wirelessly connected. The left controller 3a is used by a first user, and the right controller 4a is used by a second user. The left controller 3b is used by a third user, and the right controller 4b is used by a fourth user.

The first information processing apparatus 1a and the second information processing apparatus 1b may operate in the stationary mode. One of the first information processing apparatus 1a and the second information processing apparatus 1b may operate in the table mode, and the other may operate in the stationary mode.

At least any one or the left controller 3a, the right controller 4a, the left controller 3b, and the right controller 4b may be replaced with a second controller 7.

For example, in the game system 10 shown in FIG. 6, the first information processing apparatus 1a stores a game program for performing the game according to the exemplary embodiment, executes the game program, and functions as a parent apparatus. The second information processing apparatus 1b functions as a child apparatus. The second information processing apparatus 1b may function as the parent apparatus, and the first information processing apparatus 1a may function as the child apparatus.

In the exemplary embodiment, a two-on-two competition game that uses two screens is performed using the first information processing apparatus 1a as the parent apparatus and the second information processing apparatus 1b as the child apparatus. The competition game according to the exemplary embodiment is exemplified below.

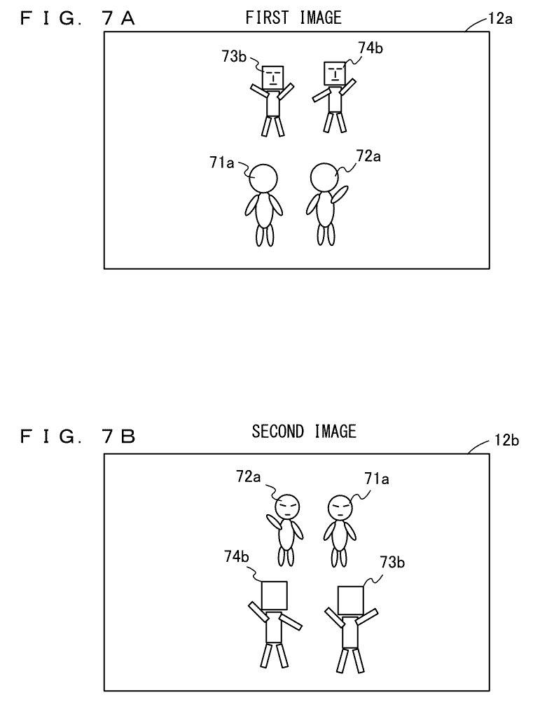

FIG. 7A is a diagram showing an example of a first image displayed on a display 12a of the parent apparatus in a case where the competition game according to the exemplary embodiment is performed. FIG. 7B is a diagram showing an example of a second image displayed on a display 12b of the child apparatus in a case where the competition game according to the exemplary embodiment is performed.

As shown in FIG. 7A, a first image viewed from behind a player character 71a and a player character 72a is displayed on the display 12a of the parent apparatus. On the other hand, as shown in FIG. 7B, a second image viewed from behind a player character 73b and a player character 74b is displayed on the display 12b of the child apparatus.

The player character 71a is controlled by the first user, and the player character 72a is controlled by the second user. The player character 73b is controlled by the third user, and the player character 74b is controlled by the fourth user.

The game according to the exemplary embodiment is a competition-type game performed between a first team including the player character 71a and the player character 72a and a second team including the player character 73b and the player character 74b. For example, the player character 71a and the player character 72a fight face-to-face against the player character 73b and the player character 74b. For example, the first user and the second user aim to defeat the opponent (the third user and the fourth user) by causing the player character 71a and the player character 72a to perform attack actions such as a punch, a kick, or the like and causing the player character 71a and the player character 72a to perform defense actions based on operation inputs.

In the game according to the exemplary embodiment, a virtual space including a first area and a second area is set. In the first area, the player character 71a and the player character 72a are placed. The player character 71a and the player character 72a move or perform predetermined actions in the first area based on operation inputs of the first user and the second user, respectively. In the second area, the player character 73b and the player character 74b are placed. The player character 73b and the player character 74b move or perform predetermined actions in the second area based on operation inputs of the third user and the fourth user, respectively. In the virtual space, a first virtual camera set on the first area side and directed from the first area to the second area is placed. In the virtual space, a second virtual camera set on the second area side and directed from the second area to the first area is also placed.

The parent apparatus performs game processing based on operation data from each controller and controls each player character. Specifically, the parent apparatus controls the player character 71a based on first parent apparatus operation data from the left controller 3a connected to the parent apparatus. The parent apparatus also controls the player character 72a based on second parent apparatus operation data from the right controller 4a connected to the parent apparatus. The child apparatus acquires operation data from the left controller 3b connected to the child apparatus and transmits the operation data as first child apparatus operation data to the parent apparatus. The child apparatus also acquires operation data from the right controller 4b connected to the child apparatus and transmits the operation data as second child apparatus operation data to the parent apparatus. The parent apparatus controls the player character 73b based on the first child apparatus operation data and controls the player character 74b based on the second child apparatus operation data.

The parent apparatus generates the first image and the second image based on the result of the game processing. Specifically, the parent apparatus generates the first image including the player character 71a and the player character 72a based on the first virtual camera. The parent apparatus generates the second image including the player character 73b and the player character 74b based on the second virtual camera. Then, the parent apparatus displays the generated first image on the display 12a of the parent apparatus and transmits the generated second image to the child apparatus. The child apparatus displays the second image received from the parent apparatus on the display 12b of the child apparatus.

As described above, in the exemplary embodiment, two controllers are connected to each of the parent apparatus and the child apparatus, and the first image and the second image are displayed on display devices of the parent apparatus and the child apparatus, whereby it is possible to perform a two-on-two competition game using the parent apparatus and the child apparatus.

The game according to the exemplary embodiment may be any game where four users compete two-on-two against each other, and for example, may be a doubles game in table tennis, tennis, badminton, or the like. The game according to the exemplary embodiment may be a beach volleyball game. In a sport game such as table tennis, tennis, badminton, beach volleyball, or the like, each player character hits a moving object (a ball, a shuttlecock, or the like) using a predetermined object (e.g., a racket, a hand portion of the player character, or the like) owned by the player character. In the game processing, a collision determination between the moving object and the predetermined object is made. If it is determined that the moving object and the predetermined object collide with each other (the determination is success), the moving object flies to the area of the opponent.

In addition to these games, a tag-team match game of professional wrestling, a shooting game, or the like may be performed.

In the above description, the first virtual camera for generating the first image to be displayed on the display device (the display 12a or the stationary monitor 5) of the parent apparatus is placed on the first area side and set in the virtual space to be directed from the first area to the second area. Similarly, the second virtual camera for generating the second image to be displayed on the display device of the child apparatus is placed on the second area side and set in the virtual space to be directed from the second area to the first area. The positions and the directions of the first virtual camera and the second virtual camera are merely examples, and may be set in the virtual space to other positions and directions. For example, the first virtual camera may be placed in the second area, and the second virtual camera may be placed in the first area. The first virtual camera may be placed to be directed from the second area to the first area, or the second virtual camera may be placed to be directed from the first area to the second area. The first virtual camera and the second virtual camera may be placed in the same direction.

In the above exemplary embodiment, the player character 71a and the player character 72a are placed in the first area, the player character 73b and the player character 74b are placed in the second area, and each character moves in the first area or the second area where the character is placed. In another exemplary embodiment, each character may be able to freely move from the area where the character is initially placed. For example, the player character 71a and the player character 72a may be initially placed in the first area, but may be able to move to the second area during the execution of the game.

In the above exemplary embodiment, a case has been described where the game is performed by connecting two controllers to the parent apparatus, connecting other two controllers to the child apparatus, the first user and the second user viewing the first image displayed on the display device of the parent apparatus, and the third user and the fourth user viewing the second image displayed on the display device of the child apparatus. In another exemplary embodiment, the game may be performed by connecting the four controllers used by the first to fourth users to the parent apparatus, the first user and the second user viewing the first image, and the third user and the fourth user viewing the second image. The four controllers used by the first to fourth users may be wirelessly connected to the child apparatus, and operation data relating to an operation on each controller may be transmitted as child apparatus operation data from the child apparatus to the parent apparatus.

In the above exemplary embodiment, player characters controlled by controllers connected to the same information processing apparatus assemble a team and compete against an opposing team including player characters controlled by controllers connected to another information processing apparatus. In another exemplary embodiment, player characters controlled by controllers connected to the same information processing apparatus may compete against each other. For example, the player character 71a and the player character 73b may assemble a team, the player character 72a and the player character 74b may assemble a team, the player character 71a and the player character 72a may compete against each other, and the player character 73b and the player character 74b may compete against each other.

In the above exemplary embodiment, a game has been assumed where four users compete two-on-two against each other. A game according to another exemplary embodiment may be a game performed by more than four users. For example, a game where a plurality of, namely three or more, users and a plurality of, namely three or more, users compete against each other may be performed. As such a game, for example, a soccer game, a basketball game, a volleyball game, a football game, or the like may be performed. In this case, the same number of controllers or different numbers of controllers may be connected to the parent apparatus and the child apparatus.

In the above exemplary embodiment, a competition game where a plurality of people compete against a plurality of people is performed using two information processing apparatuses 1. In another exemplary embodiment, a multiplay game may be performed by connecting a plurality of controllers to each of N (N is an integer greater than or equal to 3) information processing apparatuses 1. In this case, one of the N information processing apparatuses 1 functions as a parent apparatus, and the other information processing apparatuses 1 function as child apparatuses. A plurality of information processing apparatuses 1 among the N information processing apparatuses 1 may function as parent apparatuses.

In the above description, the first information processing apparatus 1a executes a game program and functions as a parent apparatus, and the second information processing apparatus 1b functions as a child apparatus. Also in a case where both the first information processing apparatus 1a and the second information processing apparatus 1b execute the game program, the above competition game may be performed.

For example, the left controller 3a and the right controller 4a are connected to the first information processing apparatus 1a, and the left controller 3b and the right controller 4b are connected to the second information processing apparatus 1b. The first information processing apparatus 1a stores a game program and executes the game program. The second information processing apparatus 1b also stores a game program and executes the game program. The first information processing apparatus 1a and the second information processing apparatus 1b communicate with each other, thereby exchanging operation data relating to operations on the controllers of the first information processing apparatus 1a and the second information processing apparatus 1b. Specifically, the first information processing apparatus 1a transmits operation data relating to operations on the left controller 3a and the right controller 4a to the second information processing apparatus 1b, and the second information processing apparatus 1b transmits operation data relating to operations on the left controller 3b and the right controller 4b to the first information processing apparatus 1a. The first information processing apparatus 1a performs game processing based on the operation data relating to the operations on the left controller 3a and the right controller 4a connected to the first information processing apparatus 1a and the operation data received from the second information processing apparatus 1b. Similarly, the second information processing apparatus 1b also performs game processing based on the operation data relating to the operations on the left controller 3b and the right controller 4b connected to the second information processing apparatus 1b and the operation data received from the first information processing apparatus 1a. Then, the first information processing apparatus 1a generates the first image relating to the result of the game processing and displays the first image on the display device of the first information processing apparatus 1a. The second information processing apparatus 1b generates the second image relating to the result of the game processing and displays the second image on the display device of the second information processing apparatus 1b.

### Details of Processes of Parent Apparatus and Child Apparatus

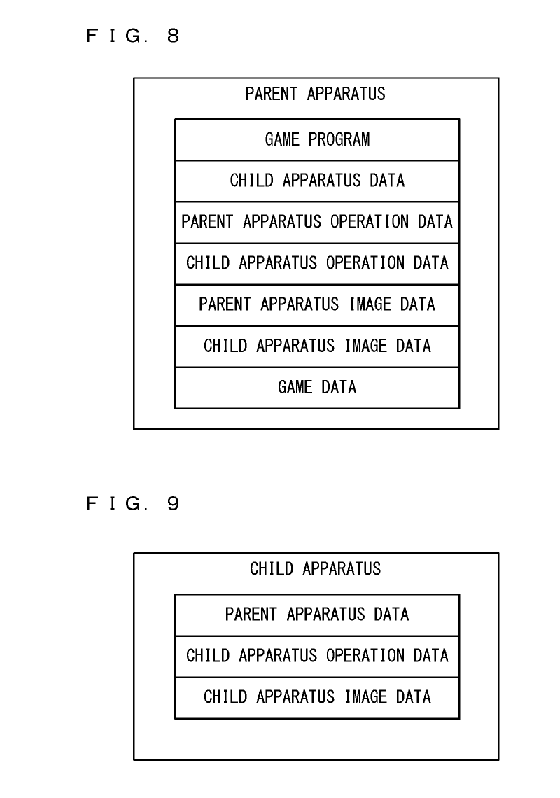

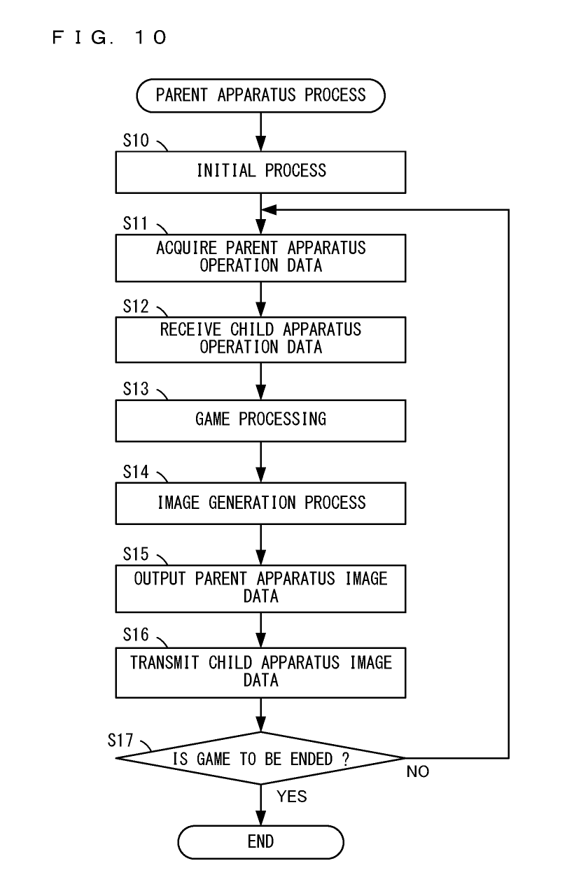

Next, the details of processes performed by a parent apparatus and a child apparatus are described. First, data stored in the parent apparatus and the child apparatus is described. FIG. 8 is a diagram showing an example of the data stored in the parent apparatus. FIG. 9 is a diagram showing an example of the data stored in the child apparatus. The data shown in FIGS. 8 and 9 is stored in a memory (any of an external storage medium, the flash memory 84, and the DRAM 85) of each main body apparatus 2.

As shown in FIG. 8, the parent apparatus stores a game program, child apparatus data, parent apparatus operation data, child apparatus operation data, parent apparatus image data, child apparatus image data, and game data.

The game program is a program for executing a predetermined game (e.g., the above competition game) and is a program for executing game processing described below.

The child apparatus data is data regarding a child apparatus connected to the parent apparatus. For example, the child apparatus data includes information (e.g., an apparatus ID, a MAC address, or the like) that identifies the child apparatus. The child apparatus data is stored with respect to each child apparatus connected to the parent apparatus.

The parent apparatus operation data is data relating to an operation performed on the controller (the first controller or the second controller) of the parent apparatus. The main body apparatus 2 acquires the parent apparatus operation data from the controller of the parent apparatus at predetermined time intervals (e.g., 1/200-second intervals).

The child apparatus operation data is data relating to an operation performed on the controller (the first controller or the second controller) of the child apparatus and is transmitted from the child apparatus. The child apparatus transmits the child apparatus operation data to the parent apparatus at predetermined time intervals (e.g., 1/60-second intervals). In a case where a plurality of child apparatuses are connected to the parent apparatus, the child apparatus operation data received from each of the child apparatuses is stored.

The parent apparatus image data is image data indicating a game image displayed on the screen of the parent apparatus (the screen of the display 12 or the stationary monitor 5) and is generated by the parent apparatus.

The child apparatus image data is image data indicating a game image displayed on the screen of the child apparatus (the screen of the display 12 or the stationary monitor 5) and is data generated by the parent apparatus and transmitted to the child apparatus. In a case where a plurality of child apparatuses are connected to the parent apparatus, the child apparatus image data of each of the plurality of child apparatuses is generated and stored. The image size (the resolution) of the child apparatus image data may be variable. For example, the image size of the child apparatus image data may change in accordance with the number of child apparatuses connected to the parent apparatus. The image size of the parent apparatus image data and the image size of the child apparatus image data may be different from each other.

The game data is data used in the competition game according to the exemplary embodiment. For example, data regarding each of the player characters (71a, 72a, 73b, and 74b) is stored as the game data. The data regarding each player character includes data indicating the shape and the external appearance of the player character and data indicating the position and the direction in the virtual space of the player character. The data regarding each player character may also include data regarding an action (an attack action, a defense action, or the like) of the player character, data regarding the physical strength value, data regarding the special ability, and the like. For example, in a case where a sport game that uses a moving object (a shuttlecock, a ball, or the like) of badminton, tennis, beach volleyball, or the like is performed, data regarding the position, the velocity, the acceleration, the rotation, and the like of the moving object (the shuttlecock, the ball, or the like) is stored as the game data. In a case where a game that uses an item such as a weapon, a tool, or the like is performed, data regarding the item is stored as the game data.

On the other hand, as shown in FIG. 9, the child apparatus stores parent apparatus data, child apparatus operation data, and child apparatus image data.

The parent apparatus data is data regarding a parent apparatus connected to the child apparatus. For example, the parent apparatus data includes information (e.g., an apparatus ID, a MAC address, or the like) that identifies the parent apparatus.

The child apparatus operation data is data relating to an operation performed on the controller (the first controller or the second controller) of the child apparatus. The main body apparatus 2 acquires the child apparatus operation data from the controller of the child apparatus at predetermined time intervals (e.g., 1/200-second intervals). The child apparatus transmits the acquired child apparatus operation data to the parent apparatus at predetermined time intervals (e.g., 1/60-second intervals).

The child apparatus image data is image data indicating a game image displayed on the screen of the child apparatus (the screen of the display 12 or the stationary monitor 5) and is data received from the parent apparatus.

The child apparatus does not store the above game program, but stores a program for participating in the game performed by the parent apparatus (a program for connecting to the parent apparatus, a program for making a participation request to the parent apparatus, or the like).

Next, the processes performed by the parent apparatus and the child apparatus are described. The following description is given on the assumption that a parent apparatus and child apparatuses are connected together in the communication form shown in FIG. 4. A parent apparatus and child apparatuses may be connected together in the communication form shown in FIG. 5.

### Parent Apparatus Process

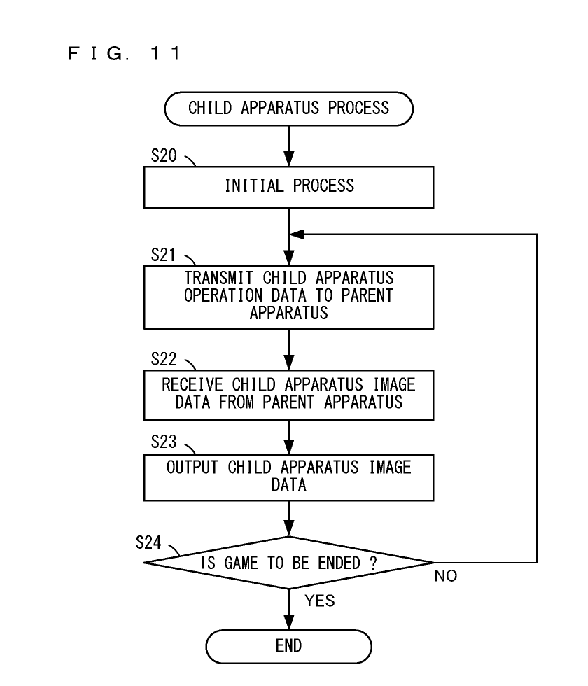

FIG. 10 is a flow chart showing an example of a parent apparatus process performed by the parent apparatus when a predetermined game is performed in the game system 10. The process shown in FIG. 10 is performed by the processor 81 of the main body apparatus 2 as the parent apparatus.

As shown in FIG. 10, first, the parent apparatus performs an initial process (step S10). In the initial process, based on an operation of a user, the process of determining a game to be executed, the process of selecting a communication form (the local communication or the Internet communication), the process of setting an information processing apparatus 1 as the parent apparatus, the process of connecting the parent apparatus and a child apparatus, a process for inviting a user (a child apparatus) to participate in the game, a process for causing a child apparatus that makes a participation request to participate in the game, and the like are performed. A communication form that configured to be selected by the user differs in accordance with the game to be executed. If the initial process ends, the parent apparatus starts the game, and from this point onward, repeatedly executes the processes of steps S11 to S17 at predetermined time intervals (e.g., 1/60-second intervals).

After the process of step S10, the parent apparatus acquires parent apparatus operation data (step S11). Specifically, if the parent apparatus operates in the stationary mode or the table mode, the parent apparatus acquires parent apparatus operation data from the first controller or the second controller wirelessly connected to the parent apparatus. For example, the parent apparatus acquires operation data acquired from the left controller 3a (or the second controller) as first parent apparatus operation data and acquires operation data acquired from the right controller 4a (or the second controller) as second parent apparatus operation data.

Next, the parent apparatus receives child apparatus operation data from child apparatuses (step S12). Specifically, the network communication section 82 of the parent apparatus receives child apparatus operation data transmitted from each child apparatus. In a case where the parent apparatus receives child apparatus operation data from a plurality of child apparatuses, the timings when the parent apparatus receive the child apparatus operation data from the child apparatuses may be different from each other.

Next, the parent apparatus performs game processing based on the parent apparatus operation data (step S13). In step S13, the parent apparatus also performs game processing based on the received child apparatus operation data.

For example, the parent apparatus updates the position of the player character 71a or causes the player character 71a to perform a predetermined action based on the first parent apparatus operation data relating to an operation on the left controller 3a. The parent apparatus also updates the position of the player character 72a or causes the player character 72a to perform a predetermined action based on the second parent apparatus operation data relating to an operation on the right controller 4a.

The parent apparatus also updates the position of the player character 73b or causes the player character 73b to perform a predetermined action based on the received first child apparatus operation data. The parent apparatus also updates the position of the player character 74b or causes the player character 74b to perform a predetermined action based on the received second child apparatus operation data.

Next, the parent apparatus performs an image generation process based on the result of the game processing (step S14). Specifically, in the image generation process, the parent apparatus generates parent apparatus image data and child apparatus image data. The parent apparatus may also generate parent apparatus sound data and child apparatus sound data.

For example, the parent apparatus generates a first image based on the first virtual camera as parent apparatus image data (see FIG. 7A). The parent apparatus also generates a second image based on the second virtual camera as child apparatus image data (see FIG. 7B).

Next, the parent apparatus outputs the parent apparatus image data generated in step S14 to the display 12 or the stationary monitor 5 (step S15). The parent apparatus also outputs a sound based on the parent apparatus sound data generated in step S14 from the speakers 88 or the speaker of the stationary monitor 5.

Next, the parent apparatus transmits the child apparatus image data generated in step S14 to the child apparatuses (step S16). Specifically, the network communication section 82 of the parent apparatus transmits the generated child apparatus image data to the child apparatuses. The network communication section 82 of the parent apparatus also transmits the generated sound data to the child apparatuses.

Next, the parent apparatus determines whether or not to end the game (step S17). For example, if the game is completed, or if the user of the parent apparatus gives an instruction to force termination of the game during the game, or if child apparatus operation data regarding forced termination of the game is received from any of the child apparatuses during the game, the determination of the parent apparatus is YES in step S17. If the determination is YES in step S17, the parent apparatus ends the game and transmits a game end notification to the child apparatuses. If the determination is NO in step S17, the parent apparatus executes the process of step S11 again. The description of the parent apparatus process ends.

While the processes of steps S11 to S17 are repeatedly executed, i.e., while a predetermined game is performed between the parent apparatus and the child apparatuses, a new child apparatus may participate.

### Child Apparatus Process

FIG. 11 is a flow chart showing an example of a child apparatus process performed by the child apparatus.

As shown in FIG. 11, first, the child apparatus performs an initial process (step S20). In the initial process, based on an operation of a user, the process of setting an information processing apparatus 1 as the child apparatus, the process of selecting a parent apparatus to which to connect, a process for transmitting a participation request to participate in a game performed by the parent apparatus, and the like are performed. If the game is started by the parent apparatus, the child apparatus ends the initial process. From this point onward, the child apparatus repeatedly executes the processes of steps S21 to S24 at predetermined time intervals (e.g., 1/60-second intervals).

If the game is started, the child apparatus transmits child apparatus operation data to the parent apparatus (step S21). Specifically, if the child apparatus operates in the stationary mode or the table mode, the child apparatus acquires operation data output from the first controller or the second controller connected to the child apparatus. Then, the network communication section 82 of the child apparatus transmits the acquired operation data as child apparatus operation data to the parent apparatus. For example, the child apparatus transmits operation data acquired from the left controller 3b (or the second controller) as first child apparatus operation data to the parent apparatus and transmits operation data acquired from the right controller 4b (or the second controller) as second child apparatus operation data to the parent apparatus. Operation data output from the controller of the child apparatus may be transmitted as child apparatus operation data to the parent apparatus, or data obtained by performing a predetermined process on operation data output from the controller of the child apparatus may be transmitted as child apparatus operation data to the parent apparatus.

Next, the child apparatus receives child apparatus image data from the parent apparatus (step S22). The child apparatus may also receive child apparatus sound data from the parent apparatus.

The frequency of transmission of the child apparatus operation data from the child apparatus and the frequency of reception (the frame rate) of the child apparatus image data by the child apparatus may be different from each other. For example, the frequency of reception of the child apparatus image data may be lower than the frequency of transmission of the child apparatus operation data. For example, in accordance with the number of child apparatuses connected to the parent apparatus, the frequencies of reception of the child apparatus image data by the child apparatuses may be lowered. In this case, the frequencies of transmission of the child apparatus operation data from the child apparatuses may be the same as each other, regardless of the number of child apparatuses connected to the parent apparatus.

Next, the child apparatus outputs the received child apparatus image data (step S23). Specifically, if the child apparatus operates in the mobile mode, the child apparatus outputs the received child apparatus image data to the display 12. If the child apparatus operates in the stationary mode, the child apparatus outputs the received child apparatus image data to the stationary monitor 5. The child apparatus may also output a sound based on the received sound data.

Next, the child apparatus determines whether or not to end the game (step S24). For example, if the child apparatus receives a game end notification from the parent apparatus, or if an instruction to force termination of the game is given in the child apparatus during the game, the child apparatus ends the game. If the game is not to be ended, the child apparatus executes the process of step S21 again. The description of the child apparatus process ends.

The processes of the above flow charts are merely examples, and for example, the order of steps may be switched, another step may be added, or some of the above steps may be omitted.

As described above, an information processing apparatus according to the exemplary embodiment operates in a mobile mode, a stationary mode, and a table mode as a plurality of play forms. In the mobile mode, the information processing apparatus performs a process relating to an operation on an operation device included in the information processing apparatus (e.g., the left controller 3 and the right controller 4 attached to the main body apparatus or the touch panel 13) and outputs an image relating to the result of the process to a display device (e.g., the display 12) included in the information processing apparatus. In the stationary mode, the information processing apparatus performs a process relating to an operation on an operation device externally connected to the information processing apparatus (e.g., the first controller or the second controller wirelessly connected to the main body apparatus) and outputs an image relating to the result of the process to a display device (e.g., the stationary monitor 5) externally connected to the information processing apparatus. In the table mode, the information processing apparatus performs a process relating to an operation on the operation device externally connected to the information processing apparatus (e.g., the first controller or the second controller wirelessly connected to the main body apparatus) and outputs an image relating to the result of the process to the display device (e.g., the display 12) included in the information processing apparatus. The information processing apparatus can also communicate with another information processing apparatus in a plurality of communication forms including Internet communication and wireless local communication.

A game system including a first information processing apparatus and a second information processing apparatus that are such information processing apparatuses is configured. The first information processing apparatus communicates with the second information processing apparatus through local communication or Internet communication. The first information processing apparatus acquires first operation data and second operation data based on operations on a first operation device (e.g., the left controller 3a) and a second operation device (e.g., the right controller 4a), respectively, connected to the first information processing apparatus. The second information processing apparatus acquires third operation data and fourth operation data based on operations on a third operation device (e.g., the left controller 3b) and a fourth operation device (e.g., the right controller 4b), respectively, connected to the second information processing apparatus and transmits the third operation data and the fourth operation data to the first information processing apparatus. The first information processing apparatus acquires the third operation data and the fourth operation data received from the second information processing apparatus.

The first information processing apparatus performs game processing based on the first to fourth operation data. Specifically, the first information processing apparatus controls a first player character based on the first operation data, controls a second player character based on the second operation data, controls a third player character based on the third operation data, and controls a fourth player character based on the fourth operation data in a virtual space as the game processing. The first information processing apparatus also generates a first image based on a first virtual camera in the virtual space and generates a second image based on a second virtual camera in the virtual space. Then, the first information processing apparatus outputs the first image to a display device (the display 12a) included in the first information processing apparatus or a display device (the stationary monitor 5) connected to the first information processing apparatus. The first information processing apparatus also transmits the second image to the second information processing apparatus. The second information processing apparatus outputs the second image to a display device (the display 12b) included in the second information processing apparatus or a display device (the stationary monitor 5) connected to the second information processing apparatus.

As described above, in the exemplary embodiment, a plurality of operation devices are connected to each of two information processing apparatuses, whereby more people than the number of information processing apparatuses can perform a multiplay game.

The first player character and the second player character may be controlled in a first range in the virtual space, and the third player character and the fourth player character may be controlled in a second range in the virtual space. The first virtual camera may be placed on the first range side and placed to be directed from the first range to the second range. The second virtual camera may be placed on the second range side and placed to be directed from the second range to the first range.

A competition game where a first team including the first player character and the second player character and a second team including the third player character and the fourth player character compete against each other may be performed. The competition game may be a game where the first team and the second team fight against each other. A game where a moving object is moved by the actions of the first to fourth player characters may be performed.

In the above exemplary embodiment, a parent apparatus provides a game application to a child apparatus. In another exemplary embodiment, a parent apparatus may provide not only a game application but also any application to a child apparatus.

While the exemplary embodiment has been described, the above description is merely illustrative, and the exemplary embodiment may be improved and modified in various manners.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of a first information processing apparatus to execute information processing comprising:
communicating with a second information processing apparatus;
acquiring first operation data and second operation data based on inputs to a first operation device and a second operation device connected to the first information processing apparatus;
acquiring third operation data and fourth operation data based on inputs to a third operation device and a fourth operation device connected to the second information processing apparatus, the third operation data and fourth operation data received from the second information processing apparatus;
in a virtual space, performing game processing comprising
controlling a first player character based on the first operation data,
controlling a second player character based on the second operation data,
controlling a third player character based on the third operation data, and
controlling a fourth player character based on the fourth operation data;
generating a first image based on a first virtual camera in the virtual space;
generating a second image based on a second virtual camera in the virtual space;
outputting the first image to a display device included in or connected to the first information processing apparatus; and
transmitting the second image to the second information processing apparatus.

2. The one or more non-transitory computer-readable media according to claim 1, wherein
the game processing further comprises:
controlling the first and second player characters in a first range in the virtual space; and
controlling the third and fourth player characters in a second range in the virtual space.

3. The one or more non-transitory computer-readable media according to claim 2, wherein
the first virtual camera is placed to be directed from the first range side to the second range side, and
the second virtual camera is placed to be directed from the second range side to the first range side.

4. The one or more non-transitory computer-readable media according to claim 2, wherein
the first and second player characters are placed to face the third and fourth player characters,
the first virtual camera is placed to be directed from a back side of the first and second player characters to the third and fourth player characters, and
the second virtual camera is placed to be directed from a back side of the third and fourth player characters to the first and second player characters.

5. The one or more non-transitory computer-readable media according to claim 3, wherein
the game processing further comprises
causing a first team including the first and second player characters and a second team including the third and fourth player characters to compete against each other.

6. The one or more non-transitory computer-readable media according to claim 5, wherein
the game processing further comprises
moving a moving object in the virtual space by actions of the first to fourth player characters based on the first to fourth operation data.

7. The one or more non-transitory computer-readable media according to claim 6, wherein
the game processing is game processing regarding a sport game where the game progresses based on a determination that is success according to the movement of the moving object.

8. A game system including a first information processing apparatus and a second information processing apparatus, the game system comprising:
one or more processors; and
one or more non-transitory computer-readable media having stored therein instructions that, when executed, cause the one or more processors to execute information processing comprising:
in the first information processing apparatus,
communicating with a second information processing apparatus;
acquiring first operation data and second operation data based on inputs to a first operation device and a second operation device connected to the first information processing apparatus;
acquiring third operation data and fourth operation data based on inputs to a third operation device and a fourth operation device, respectively, connected to the second information processing apparatus, the third operation data and fourth operation data received from the second information processing apparatus;
in a virtual space, performing game processing comprising
controlling a first player character based on the first operation data,
controlling a second player character based on the second operation data,
controlling a third player character based on the third operation data, and
controlling a fourth player character based on the fourth operation data;
generating a first image based on a first virtual camera in the virtual space;
generating a second image based on a second virtual camera in the virtual space;
outputting the first image to a display device included in or connected to the first information processing apparatus; and
transmitting the second image to the second information processing apparatus, and
in the second information processing apparatus,
communicating with the first information processing apparatus;
transmitting the third operation data and the fourth operation data based on inputs to the third operation device and the fourth operation device, respectively, connected to the second information processing apparatus to the first information processing apparatus; and
outputting the second image received from the first information processing apparatus to a display device included in or connected to the second information processing apparatus.

9. The game system according to claim 8, wherein
in the first information processing apparatus, the game processing further comprises:
controlling the first and second player characters in a first range in the virtual space; and
controlling the third and fourth player characters in a second range in the virtual space.

10. The game system according to claim 9, wherein
the first virtual camera is placed to be directed from the first range side to the second range side, and
the second virtual camera is placed to be directed from the second range side to the first range side.

11. The game system according to claim 9, wherein
the first and second player characters are placed to face the third and fourth player characters,
the first virtual camera is placed to be directed from a back side of the first and second player characters to the third and fourth player characters, and
the second virtual camera is placed to be directed from a back side of the third and fourth player characters to the first and second player characters.

12. The game system according to claim 10, wherein
in the first information processing apparatus, the game processing further comprises
causing a first team including the first and second player characters and a second team including the third and fourth player characters to compete against each other.

13. The game system according to claim 12, wherein
in the first information processing apparatus, the game processing further comprises
moving a moving object in the virtual space by actions of the first to fourth player characters based on the first to fourth operation data.

14. The game system according to claim 13, wherein
the game processing is game processing regarding a sport game where the game progresses based on a determination that is success according to the movement of the moving object.

15. An information processing method performed in a game system including a first information processing apparatus and a second information processing apparatus, the information processing method comprising:
in the first information processing apparatus,
communicating with a second information processing apparatus;
acquiring first operation data and second operation data based on inputs to a first operation device and a second operation device connected to the first information processing apparatus;
acquiring third operation data and fourth operation data based on inputs to a third operation device and a fourth operation device, respectively, connected to the second information processing apparatus, the third operation data and fourth operation data received from the second information processing apparatus;
in a virtual space, performing game processing comprising
controlling a first player character based on the first operation data,
controlling a second player character based on the second operation data,
controlling a third player character based on the third operation data, and
controlling a fourth player character based on the fourth operation data;
generating a first image based on a first virtual camera in the virtual space;
generating a second image based on a second virtual camera in the virtual space;
outputting the first image to a display device included in or connected to the first information processing apparatus; and
transmitting the second image to the second information processing apparatus, and
in the second information processing apparatus,
communicating with the first information processing apparatus;
transmitting the third operation data and the fourth operation data based on inputs to the third operation device and the fourth operation device, respectively, connected to the second information processing apparatus to the first information processing apparatus; and
outputting the second image received from the first information processing apparatus to a display device included in or connected to the second information processing apparatus.

16. The information processing method according to claim 15, further comprising, in the first information processing apparatus, as the game processing:
controlling the first and second player characters in a first range in the virtual space; and
controlling the third and fourth player characters in a second range in the virtual space.

17. The information processing method according to claim 16, wherein
the first virtual camera is placed to be directed from the first range side to the second range side, and
the second virtual camera is placed to be directed from the second range side to the first range side.

18. The information processing method according to claim 16, wherein
the first and second player characters are placed to face the third and fourth player characters,
the first virtual camera is placed to be directed from a back side of the first and second player characters to the third and fourth player characters, and
the second virtual camera is placed to be directed from a back side of the third and fourth player characters to the first and second player characters.

19. The information processing method according to claim 17, further comprising, in the first information processing apparatus, as the game processing,
causing a first team including the first and second player characters and a second team including the third and fourth player characters to compete against each other.

20. The information processing method according to claim 19, further comprising, in the first information processing apparatus, as the game processing,
moving a moving object in the virtual space by actions of the first to fourth player characters based on the first to fourth operation data.

21. The information processing method according to claim 20, wherein
the game processing is game processing regarding a sport game where the game progresses based on a determination that is success according to the movement of the moving object.

22. An information processing apparatus comprising:
one or more processors; and
one or more non-transitory computer-readable media having stored therein instructions that, when executed, cause the one or more processors to execute information processing comprising:
communicating with a second information processing apparatus;
acquiring first operation data and second operation data based on inputs to a first operation device and a second operation device connected to the information processing apparatus;
acquiring third operation data and fourth operation data based on inputs to a third operation device and a fourth operation device connected to the second information processing apparatus, the third operation data and fourth operation data received from the second information processing apparatus;
in a virtual space, performing game processing comprising
controlling a first player character based on the first operation data,
controlling a second player character based on the second operation data,
controlling a third player character based on the third operation data, and
controlling a fourth player character based on the fourth operation data;
generating a first image based on a first virtual camera in the virtual space;
generating a second image based on a second virtual camera in the virtual space;
outputting the first image to a display device included in or connected to the information processing apparatus; and
transmitting the second image to the second information processing apparatus.

23. The information processing apparatus according to claim 22, wherein
the information processing further comprises, as the game processing:
controlling the first and second player characters in a first range in the virtual space; and
controlling the third and fourth player characters in a second range in the virtual space.

24. The information processing apparatus according to claim 23, wherein
the first virtual camera is placed to be directed from the first range side to the second range side, and
the second virtual camera is placed to be directed from the second range side to the first range side.

25. The information processing apparatus according to claim 23, wherein
the first and second player characters are placed to face the third and fourth player characters,
the first virtual camera is placed to be directed from a back side of the first and second player characters to the third and fourth player characters, and
the second virtual camera is placed to be directed from a back side of the third and fourth player characters to the first and second player characters.

26. The information processing apparatus according to claim 24, wherein
the information processing further comprises, as the game processing,
causing a first team including the first and second player characters and a second team including the third and fourth player characters to compete against each other.

27. The information processing apparatus according to claim 26, wherein
the information processing further comprises, as the game processing,
moving a moving object in the virtual space by actions of the first to fourth player characters based on the first to fourth operation data.

28. The information processing apparatus according to claim 27, wherein
the game processing is game processing regarding a sport game where the game progresses based on a determination that is success according to the movement of the moving object.
